(19) United States
(12) Patent Application Publication
(10) Pub. No.: US 2025/0280415 A1
(43) Pub. Date: Sep. 4, 2025

(54) WIRELESS COMMUNICATION METHOD AND DEVICE THEREOF

(71) Applicant: ZTE CORPORATION, Shenzhen, Guangdong (CN)

(72) Inventors: Jiajun XU, Shenzhen, Guangdong (CN); Bo DAI, Shenzhen, Guangdong (CN); Mengzhu CHEN, Shenzhen, Guangdong (CN); Hong TANG, Shenzhen, Guangdong (CN); Jun XU, Shenzhen, Guangdong (CN); Jianqiang DAl, Shenzhen, Guangdong (CN); Xiaoying MA, Shenzhen, Guangdong (CN)

(21) Appl. No.: 18/868,201

(22) PCT Filed: Sep. 5, 2022
(86) PCT No.: PCT/CN2022/117136

§ 371 Date: Nov. 22, 2024

(51) Int. Cl. H04W 72/21; H04L 5/00; H04W 72/115

(52) U.S. Cl. CPC H04W 72/21; H04L 5/0005; H04L 5/0055; H04W 72/115

(57) ABSTRACT

A wireless communication method for use in a wireless terminal is disclosed. The method comprises receiving, from a wireless network node, a control signaling comprising resource configuration information associated with one or more first data transmission resources, determining first resources in the one of a plurality of the first data transmission resources and/or second resources in the one of the plurality of the first data transmission resources based on a first condition, and transmitting, to the wireless network node, at least one of: data on the first resources, an uplink control information, UCI, signaling on the second resources, or data and an uplink control information, UCI, signaling on the second resources.

### CROSS-REFERENCE TO RELATED APPLICATIONS

The present application is proposed based on International Application No. PCT/CN2022/117136, filed on Sep. 5, 2022, the disclosure of which is hereby incorporated by reference in its entirety.

### TECHNICAL FIELD

This document is directed generally to wireless communications and in particular to uplink (UL) transmissions.

In beyond-5G and -6G communications, one of the promising services is characterized by quasi-periodicity (jitter impact), large and various data amount and stringent latency requirements, including, e.g., extended reality (XR) service. In the existing network, a configured grant (CG) is capable of conveying periodic data by using preconfigured resources without a time consuming grant request. However, owing to the service characteristics of high reliability as well as large and various data amount, the preconfigured resources are likely to be large and trigger a UL control information (UCI) multiplexing on the resources, which causes a decrease in reliability of data transmissions in UL transmissions (e.g., CG physic uplink shared channel (PUSCH)). Thus, how to ensure the transmission reliability of the data transmission when considering the UCI multiplexing on the CG PUSCH becomes a topic to be discussed.

### SUMMARY

This document relates to methods and devices for UL transmissions, in particular to methods and devices for multiplexing UCI in CG PUSCH transmissions.

The present disclosure relates to a wireless communication method for use in a wireless terminal. The method comprises:
receiving, from a wireless network node, a control signaling comprising resource configuration information associated with one or more first data transmission resources,
determining first resources in the one of a plurality of the first data transmission resources and/or second resources in the one of the plurality of the first data transmission resources based on a first condition, and
transmitting, to the wireless network node, at least one of:
   data on the first resources,
   an uplink control information, UCI, signaling on the second resources, or
   data and an uplink control information, UCI, signaling on the second resources.

Various embodiments may preferably implement the following features:
Preferably, the UCI signaling comprises at least one of: a hybrid automatic repeat request acknowledge, a channel state information report, activation/deactivation indication information, associated with the first data transmission resources, traffic latency information, associated with a maximum time of a packet transmission, buffer status information, associated with a size of a packet, traffic reliability information, associated with a maximum packet error ratio of a transport block in a packet, remaining time for transmission information, associated with a remaining time of a packet transmission, or packet arrival information, associated with an arrival time of a packet.

Preferably, the control signaling includes at least one of: a radio resource control signaling, a media access control element or a downlink control information signaling.

Preferably, the first data transmission resources are configured based on an uplink configured grant.

Preferably, the data is transmitted on the first resources and the UCI signaling is transmitted on the second resources.

Preferably, the resource configuration information includes at least one of: a plurality of multiplexing configurations, wherein each multiplexing configuration indicates the one or more first data transmission resources comprising the first resources and/or second resources, time domain resource assignment information for at least one of the first resources or the second resources, frequency domain resource assignment information for at least one of the first resources or the second resources, offset information used for determining a time and frequency location of the second resources, repetition information, associated with a number of times of repeating a transport block of the data, or priority information, associated with a transmission priority of the data or the UCI signaling.

Preferably, the plurality of multiplexing configurations is determined as at least one of the following: shared time domain resource assignment and orthogonal frequency domain resource assignment; shared frequency domain resource assignment and orthogonal time domain resource assignment; both orthogonal time and frequency resource assignment; both shared time and frequency resource assignment.

Preferably, the first resources and second resources of a multiplexing configuration are different from the first resources and second resources of another multiplexing configuration.

Preferably, the offset information is associated with a bit length of UCI signaling, wherein a value of the offset information is a positive decimal.

Preferably, the offset information indicates a value for each multiplexing configuration.

Preferably, the plurality of multiplexing configurations share a same value indicated by the offset information.

Preferably, the first condition is associated with at least one of: an existence situation of the UCI signaling; an overlapping situation between PUCCH resources for the UCI signaling and the one or more first data transmission resources; repetition information associated with a number of times of repeating a transport block of the data, or a priority information associated with a transmission priority of the data or the UCI signaling.

Preferably, determining the first resources in the one of the plurality of the first data transmission resources and/or the second resources in the one of the plurality of the first data transmission resources based on the first condition includes at least one of:
if there is no UCI signaling transmission, the first resources of one of the multiplexing configurations which does not have the second resources are determined for transmitting the data,
if there are one or more UCI signaling transmissions and physical uplink control channel, PUCCH, resources for the UCI signaling do not overlap the one or more first data transmission resources, the first resources of one of a plurality of multiplexing configurations which does not have the second resources are determined for transmitting the data,
if there are one or more UCI signaling transmissions and PUCCH resources for the UCI signaling overlap the one or more first data transmission resources, the second resources of one of a plurality of multiplexing configurations are determined for the first data transmission and UCI signaling transmission,
if there are one or more UCI signaling transmissions and PUCCH resources for the UCI signaling overlaps the one or more first data transmission resources, the first resources and the second resources of one of a plurality of multiplexing configurations are determined for respectively transmitting the data and the UCI signaling,
if there are one or more UCI signaling transmissions, the first resources and at least one third resource of one of a plurality of multiplexing configurations are determined for transmitting the data, wherein the data transmitted on the third resource is a duplication of the data transmitted on the first resources, or
if PUCCH resources for the UCI signaling overlap the one or more first data transmission resources and the data has a priority higher than a priority of the UCI signaling, the first resources of one of a plurality of multiplexing configurations are determined for transmitting the data and the second resources of the same multiplexing configuration are canceled.

Preferably, the first resources and the at least one third resource are consecutive resources in the one or more data transmission resources.

Preferably, the first resources and the at least one third resource are inconsecutive resources in the one or more data transmission resources.

Preferably, the first resources of one of the plurality of multiplexing configurations are determined for transmitting the data and the second resources of the same multiplexing configuration are canceled, and priority information in the resource configuration information indicates that data transmissions have a higher priority than UCI signaling transmissions.

Preferably, a second data transmission resource is determined for transmitting the UCI signaling.

Preferably, the data transmission resource is a physical uplink shared channel resource, a transport block on a physical uplink shared channel, a configured grant physical uplink shared channel resource or a transport block on a configured grant physical uplink shared channel.

The present disclosure relates to a wireless communication method for use in a wireless network node. The method comprises:
transmitting, to a wireless terminal, a control signaling comprising resource configuration information associated with one or more first data transmission resources,
determining first resources in the one of a plurality of the first data transmission resources and/or second resources in the one of the plurality of the first data transmission resources based on a first condition, and
receiving, from the wireless terminal, at least one of:
   data on the first resources,
   an uplink control information, UCI, signaling on the second resources, or
   data and an uplink control information, UCI, signaling on the second resources.

Various embodiments may preferably implement the following features:
Preferably, the UCI signaling comprises at least one of: a hybrid automatic repeat request acknowledge, a channel state information report, activation/deactivation indication information, associated with the first data transmission resources, traffic latency information, associated with a maximum time of a packet transmission, buffer status information, associated with a size of a packet, traffic reliability information, associated with a maximum packet error ratio of a transport block in a packet, remaining time for transmission information, associated with a remaining time of a packet transmission, or packet arrival information, associated with an arrival time of a packet.

Preferably, the control signaling includes at least one of: a radio resource control signaling, a media access control element or a downlink control information signaling.

Preferably, the first data transmission resources are configured based on an uplink configured grant.

Preferably, the data is received on the first resources and the UCI signaling is received on the second resources.

Preferably, the resource configuration information includes at least one of: a plurality of multiplexing configurations, wherein each multiplexing configuration indicates the one or more first data transmission resources comprising the first resources and/or second resources, time domain resource assignment information for at least one of the first resources or the second resources, frequency domain resource assignment information for at least one of the first resources or the second resources, offset information used for determining a time and frequency location of the second resources, repetition information, associated with a number of times of repeating a transport block of the data, or priority information, associated with a transmission priority of the data or the UCI signaling.

Preferably, the plurality of multiplexing configurations are determined as at least one of the following: shared time domain resource assignment and orthogonal frequency domain resource assignment; shared frequency domain resource assignment and orthogonal time domain resource assignment; both orthogonal time and frequency resource assignment; both shared time and frequency resource assignment.

Preferably, the first resources and second resources of a multiplexing configuration are different from the first resources and second resources of another multiplexing configuration.

Preferably, the offset information is associated with a bit length of UCI signaling, wherein a value of the offset information is a positive decimal.

Preferably, the offset information indicates a value for each multiplexing configuration.

Preferably, the plurality of multiplexing configurations share a same value indicated by the offset information.

Preferably, the first condition is associated with at least one of: an existence situation of the UCI signaling; an overlapping situation between PUCCH resources for the UCI signaling and the one or more first data transmission resources; repetition information associated with a number of times of repeating a transport block of the data, or a priority information associated with a transmission priority of the data or the UCI signaling.

Preferably, determining the first resources in the one of the plurality of the first data transmission resources and/or the second resources in the one of the plurality of the first data transmission resources based on the first condition includes at least one of:
if there is no UCI signaling transmission, the first resources of one of the multiplexing configurations which does not have the second resources are determined for receiving the data,
if there are one or more UCI signaling transmissions and physical uplink control channel, PUCCH, resources for the UCI signaling do not overlap the one or more first data transmission resources, the first resources of one of a plurality of multiplexing configurations which does not have the second resources are determined for receiving the data,
if there are one or more UCI signaling transmissions and PUCCH resources for the UCI signaling overlap the one or more first data transmission resources, the second resources of one of a plurality of multiplexing configurations are determined for the first data reception and UCI signaling reception,
if there are one or more UCI signaling transmissions and PUCCH resources for the UCI signaling overlaps the one or more first data transmission resources, the first resources and the second resources of one of a plurality of multiplexing configurations are determined for respectively receiving the data and the UCI signaling,
if there are one or more UCI signaling transmissions, the first resources and at least one third resource of one of a plurality of multiplexing configurations are determined for receiving the data, wherein the data received on the third resource is a duplication of the data received on the first resources, or
if PUCCH resources for the UCI signaling overlap the one or more first data transmission resources and the data has a priority higher than a priority of the UCI signaling, the first resources of one of a plurality of multiplexing configurations are determined for receiving the data and the second resources of the same multiplexing configuration are canceled.

Preferably, the first resources and the at least one third resource are consecutive resources in the one or more data transmission resources.

Preferably, the first resources and the at least one third resource are inconsecutive resources in the one or more data transmission resources.

Preferably, the first resources of one of the plurality of multiplexing configurations are determined for receiving the data and the second resources of the same multiplexing configuration are canceled, and priority information in the resource configuration information indicates that data transmissions have a higher priority than UCI signaling transmissions.

Preferably, a second data transmission resource is determined for receiving the UCI signaling.

Preferably, the data transmission resource is a physical uplink shared channel resource, a transport block on a physical uplink shared channel, a configured grant physical uplink shared channel resource or a transport block on a configured grant physical uplink shared channel.

The present disclosure relates to a wireless terminal. The wireless terminal comprises:
a communication unit, configured to receive, from a wireless network node, a control signaling comprising resource configuration information associated with one or more first data transmission resources, and
a processor configured to determine first resources in the one of a plurality of the first data transmission resources and/or second resources in the one of the plurality of the first data transmission resources based on a first condition,
wherein the communication unit is further configured to transmit at least one of:
   data on the first resources,
   an uplink control information, UCI, signaling on the second resources, or
   data and an uplink control information, UCI, signaling on the second resources.

Various embodiments may preferably implement the following feature:

Preferably, the processor is further configured to perform any of aforementioned wireless communication methods.

The present disclosure relates to a wireless network node. The wireless network node comprises:
a communication unit, configured to transmit, to a wireless terminal, a control signaling comprising resource configuration information associated with one or more first data transmission resources, and
a processor configured to determine first resources in the one of a plurality of the first data transmission resources and/or second resources in the one of the plurality of the first data transmission resources based on a first condition,
wherein the communication unit is further configured to receive, from the wireless terminal, at least one of:
   data on the first resources,
   an uplink control information, UCI, signaling on the second resources, or
   data and an uplink control information, UCI, signaling on the second resources.

Various embodiments may preferably implement the following feature:

Preferably, the processor is further configured to perform any of aforementioned wireless communication methods.

The present disclosure relates to a computer program product comprising a computer-readable program medium code stored thereupon, the code, when executed by a processor, causing the processor to implement a wireless communication method recited in any one of foregoing methods.

The exemplary embodiments disclosed herein are directed to providing features that will become readily apparent by reference to the following description when taken in conjunction with the accompany drawings. In accordance with various embodiments, exemplary systems, methods, devices and computer program products are disclosed herein. It is understood, however, that these embodiments are presented by way of example and not limitation, and it will be apparent to those of ordinary skill in the art who read the present disclosure that various modifications to the disclosed embodiments can be made while remaining within the scope of the present disclosure.

Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

### BRIEF DESCRIPTION OF THE DRAWINGS

The above and other aspects and their implementations are described in greater detail in the drawings, the descriptions, and the claims.

FIG. 1 shows a schematic diagram of a network according to an embodiment of the present disclosure.

FIG. 2 shows a schematic diagram of a procedure of triggering UCI multiplexing on the PUSCH according to an embodiment of the present disclosure.

FIG. 3 shows a schematic diagram of multiplexing the UCI in the PUSCH according to an embodiment of the present disclosure.

FIG. 4A and FIG. 4B show schematic diagrams of configurations of the CG PUSCH according to embodiments of the present disclosure.

FIG. 5 shows a schematic diagram of a configuration of the CG PUSCH according to an embodiment of the present disclosure.

FIG. 6 shows a schematic diagram of a configuration of the CG PUSCH according to an embodiment of the present disclosure.

FIG. 7 shows a flowchart of a method according to an embodiment of the present disclosure.

FIG. 8 shows a schematic diagram of the remaining time for transmission and packet latency requirement according to an embodiment of the present disclosure.

FIGS. 9 to 12 show schematic diagrams of resource assignments for multiplexing configurations according to embodiments of the present disclosure.

FIGS. 13 to 16 show schematic diagrams of uplink transmissions according to embodiments of the present disclosure.

FIG. 17 shows a flowchart of a method according to an embodiment of the present disclosure.

FIG. 18 shows an example of a schematic diagram of a wireless terminal according to an embodiment of the present disclosure.

FIG. 19 shows an example of a schematic diagram of a wireless network node according to an embodiment of the present disclosure.

### DETAILED DESCRIPTION

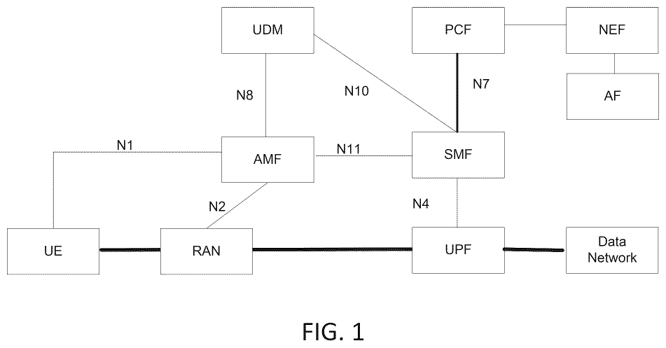

FIG. 1 shows a schematic diagram of a network (architecture) according to an embodiment of the present disclosure. In FIG. 1, the network comprises the following network functions/entities:

### 1) UE: User Equipment

### 2) RAN: Radio Access Network

In the present disclosure, the RAN may be equal to RAN node or next-generation RAN (NG-RAN) (node).

### 3) AMF: Access and Mobility Management Function

The AMF includes the following functionalities: Registration Management, Connection Management, Reachability Management and Mobility Management. The AMF terminates the RAN Control Plane (CP) interface N2 and NAS interface N1, non-access stratum (NAS) ciphering and integrity protection. It also distributes the session management (SM) NAS to proper session management functions (SMFs) via interface N11. The AMF provides services for other consumer Network Functions (NFs) to subscribe or get notified of the mobility related events and information.

### 4) SMF: Session Management Function

The SMF includes the following functionalities: session establishment, modification and release, UE IP address allocation & management (including optional authorization functions), selection and control of User Plane (UP) function, downlink data notification. The SMF can subscribe the mobility related events and information from AMF.

### 5) UPF: User Plane Function

The UPF includes the following functionalities: serving as an anchor point for intra-/inter-radio access technology (RAT) mobility and the external session point of interconnect to Data Network, packet routing & forwarding as indicated by SMF, traffic usage reporting, quality of service (QoS) handling for the UP, downlink packet buffering and downlink data notification triggering, etc.

### 6) UDM: Unified Data Management

The UDM manages the subscription profile for the UEs. The subscription includes the data used for mobility management (e.g., restricted area), session management (e.g., QoS profile per slice per DNN). The subscription data also includes the slice selection parameters which is used for AMF to select a proper SMF. The AMF and SMF get the subscription from UDM. The subscription data is stored in the Unified Data Repository (UDR). The UDM uses such data upon reception of request from AMF or SMF.

### 7) PCF: Policy Control Function

The PCF supports unified policy framework to govern network behavior. The PCF provides access management policy to the AMF, or session management policy to the SMF, and/or UE policy to the UE. The PCF can access the UDR to obtain subscription information relevant for policy decisions. The PCF may also generate the policy to govern network behavior based on the subscription and indication from an application function (AF). Then, the PCF can provide policy rules to CP functions (e.g., the AMF and/or the SMF) to enforce the CP functions.

### 8) NEF: Network Exposure Function

The NEF supports exposure of capability and events of the network towards the AF. A third party AF can invoke the service provided by the network via the NEF and the NEF performs authentication and authorization of the third party applications. The NEF also provides translation of the information exchanged with the AF and information exchanged with the internal NF.

### 9) AF: Application Function

The AF interacts with the Core Network in order to provide services, e.g., to support: application influence on traffic routing, accessing the NEF, interacting with the Policy framework for policy control etc. The AF may be considered to be trusted by the operator can be allowed to interact directly with relevant NFs. The AF not allowed by the operator to access directly the NFs shall use the external exposure framework via the NEF to interact with relevant NFs. The AF may store the application information in the UDR via the NEF.

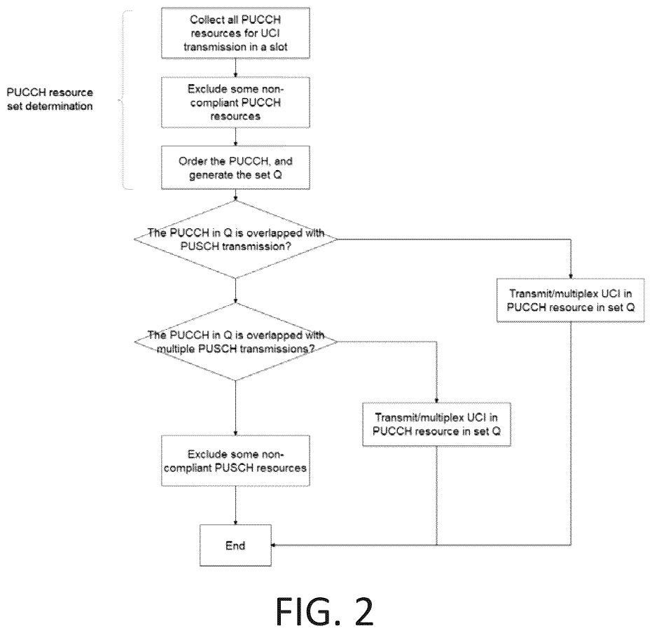

FIG. 2 shows a schematic diagram of a procedure of triggering UCI multiplexing on the PUSCH according to an embodiment of the present disclosure. Based on the procedure in FIG. 2, the UCI is multiplexed in the PUSCH when PUCCH is overlapped with PUSCH in time domain.

In an embodiment of the UCI being multiplexed in the PUSCH, offset information beta_offset is used for determined the coded bit length of UCI signaling, wherein the UCI signaling may include at least one of HARQ-ACK information, a CSI report part 1 and a CSI report part 2. The coded bit length of HARQ-ACK information, the CSI report part 1 and the CSI report part 2 is expressed as:

$${Q}_{ACK}^{′} = min \{ ⌈ \frac{( {O}_{ACK} + {L}_{ACK} ) \cdot {β}_{offset}^{PUSCH} \cdot {\sum }_{l = 0}^{{N}_{symb , {all}^{- 1}}^{PUSCH}} {M}_{sc}^{UCI} ( l )}{{{\sum }_{r = 0}}^{{C}_{UL - {SCH}^{- 1}}} {K}_{r}} ⌉ , ⌈ α {\sum }_{l = {l}_{0}}^{{N}_{symb , {all}^{- 1}}^{PUSCH}} {M}_{sc}^{UCI} ( l ) ⌉ \} \\ {Q}_{CSI - 1}^{′} = min \{ ⌈ \frac{( {o}_{CSI - 1} + {L}_{CSI - 1} ) \cdot {β}_{offset}^{PUSCH} \cdot {\sum }_{l = 0}^{{N}_{symb , {all}^{- 1}}^{PUSCH}} {M}_{sc}^{UCI} ( l )}{{\sum }_{r = 0}^{{C}_{UL - {SCH}^{- 1}}} {K}_{r}} ⌉ , ⌈ α \cdot {\sum }_{l = 0}^{{N}_{symb , {all}^{- 1}}^{PUSCH}} {M}_{sc}^{UCI} ( l ) ⌉ - {Q}_{ACK / CG - UCI}^{′} \} \\ {Q}_{C S I - 2}^{′} = min \{ ⌈ \frac{( {o}_{CSI - 2} + {L}_{CSI - 2} ) \cdot {β}_{offset}^{PUSCH} \cdot {\sum }_{l = 0}^{{N}_{symb , {all}^{- 1}}^{PUSCH}} {M}_{sc}^{UCI} ( l )}{{\sum }_{r = 0}^{{C}_{UL - {SCH}^{- 1}}} {K}_{r}} ⌉ , ⌈ α \cdot {\sum }_{l = 0}^{{N}_{symb , {all}^{- 1}}^{PUSCH}} {M}_{sc}^{UCI} ( l ) ⌉ - {Q}_{ACK / CG - UCI}^{′} - {Q}_{CSI - 1}^{′} \} ,$$

respectively.

Wherein O_{ACK} O_{CSI-1}, O_{CsI-2} respectively denotes the bit length of the HARQ-ACK information, the CSI report part 1, the CSI report part 2 before channel coding, L_{ACK} L_{CSI-1}, L_{CSI-2} denotes the CRC bit lengths, β_{offset}^{PUSCH} denotes the beta offset of the UCI signaling multiplexing in the PUSCH, M_{SC}^{UCI} (l) (denotes the available subcarriers for the UCI signaling multiplexing in the l-th symbol, Kr denotes the bit length in the r-th code block.

In general, the UCI signaling starts to be multiplexed in the first subcarrier in the first symbol, except the subcarriers transmitting the reference signaling, such as a DM-RS (Demodulation reference signal).

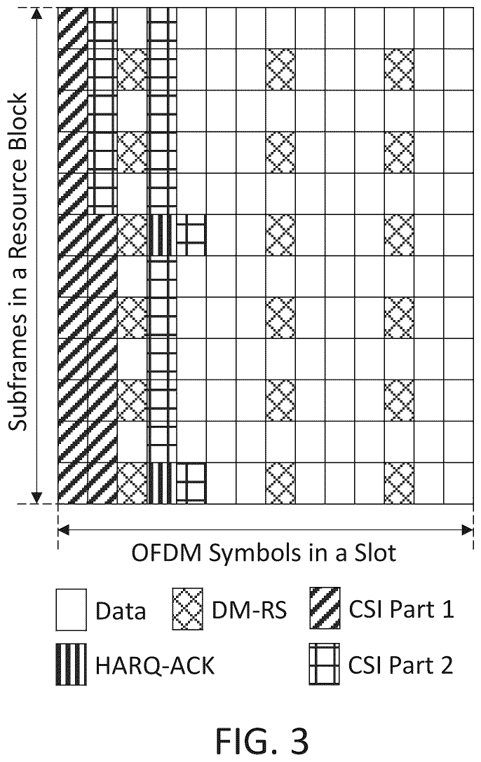

FIG. 3 shows a schematic diagram of multiplexing the UCI in the PUSCH according to an embodiment of the present disclosure. In FIG. 3, the coded bit length of the HARQ-ACK information, the CSI report part 1 and the CSI report part 2 are 2 bits, 19bits and 19 bits, respectively.

In an embodiment, when the UCI is multiplexed in the (CG) PUSCH, the (CG) PUSCH is divided into two resources, wherein the first resources comprise the resources for the CG PUSCH or the resources for transmitting data while the second resources comprise the resources for transmitting the UCI signaling.

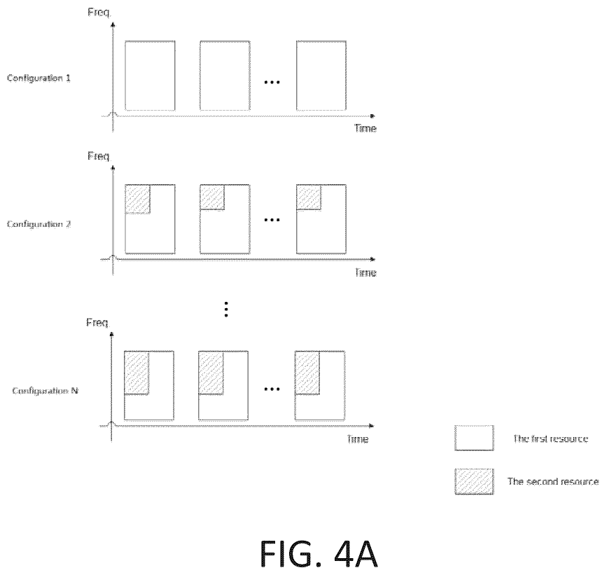

FIGS. 4A and 4B shows schematic diagrams of configurations of the CG PUSCH according to embodiments of the present disclosure. In FIGS. 4A and 4B, there are a plurality of configurations for the CG PUSCH. In FIG. 4A, there is no second resource in the CG PUSCH in one of configurations (i.e., configuration 1), while there are second resources with different time positions/locations and/or different frequency domain positions in the CG PUSCH in other configurations (i.e., configurations 2 to N, where N is an integer). When the UCI signaling is multiplexed in the CG PUSCH, one of configurations 2 to N with the second resources is used. When the UCI signaling is not multiplexed in the CG PUSCH, the configuration 1 without the second resources is used. In FIG. 4A, the data is transmitted on the first resources

In FIG. 4B, the definition of the second resources is different from that of the second resources in FIG. 4A. Specifically, the second resources in FIG. 4B are configured for transmitting both data and UCI signaling. That is the second resources in FIG. 4B may be considered as a sum of the first resources and the second resources in FIG. 4A in an embodiment. In addition, in FIG. 4B, the second resources in different configurations having the second resources are arranged at different time positions and/or different frequency positions. When the UCI signaling is multiplexed in the CG PUSCH, one of configurations 2 to N with the second resources is used. The data and the UCI signaling are transmitted on the second resources of the used configuration. When the UCI signaling is not multiplexed in the CG PUSCH, the configuration 1 without the second resources is used. That is the data is transmitted on the first resources of the configuration 1.

Note that, in the present disclosure, the first resources may comprise at least one slots in at least one subframe (e.g., on CG-PUSCH). The combination of the first resources (i.e., at least one slots in at least one subframe) may be considered as a single first resource in some embodiments. Similarly, the combination of the second resources (i.e., at least one slots in at least one subframe) may be considered as a single second resource in some embodiments. In some embodiments, the first resources and the second resources may be regarded as an integrated resource.

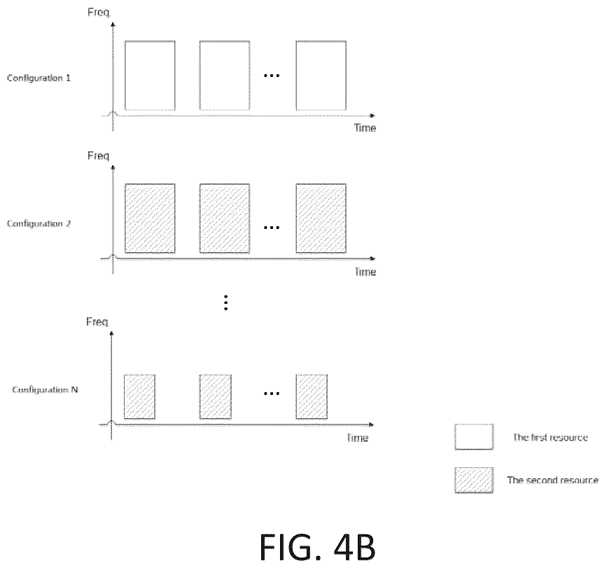

FIG. 5 shows a schematic diagram of a configuration of the CG PUSCH according to an embodiment of the present disclosure. In FIG. 5, there is not any pre-configured second resource in each CG PUSCH. When the UCI signaling is multiplexed in the CG PUSCH, a transport block repetition is activated. That is the transport block punctured by the UCI signaling may be repeated in subsequent transport block(s) on the CG PUSCH. Note that the repeated/duplicated transport block(s) may be in consecutive slots or non-consecutive slots. Specifically, in FIG. 5, the transport block TB1 is punctured by the UCI signaling (i.e., comprises the (second) resources for the UCI). Under such condition, the TB1 is repeated in the following CG PUSCHs. The transport blocks TB2 and TB3 are not repeated since not having the (second) resources for the UCI signaling. Note that the repeated TB1 may be configured in non-consecutive slots. For example, the repeated TB1 may be configured at slots after TB2 and/or TB3.

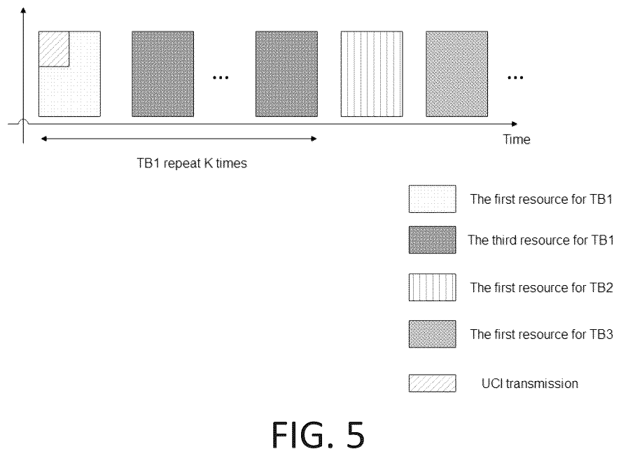

FIG. 6 shows a schematic diagram of a configuration of the CG PUSCH according to an embodiment of the present disclosure. In FIG. 6, the CG PUSCH is not allowed to be multiplexed with the UCI signaling. When the CG-PUSCH and the UCI signaling collide/overlap, the CG PUSCH is transmitted and the UCI signaling is canceled because the CG PUSCH is configured with a higher priority (than that of the UCI signaling).

In some embodiments, to ensure a transmission reliability of data transmissions, several solutions are considered for the resource collision between the UCI signaling and the data (e.g., CG PUSCH), including at least one of:
configuring more than one multiplexing configurations to allow a configuration switching, where each configuration comprises the first resources and the second resources with different time and frequency domains (see FIG. 4A or FIG. 4B),
activating transport block repetition (see FIG. 5), and
configuring priority to ensure data transmission (see FIG. 6).

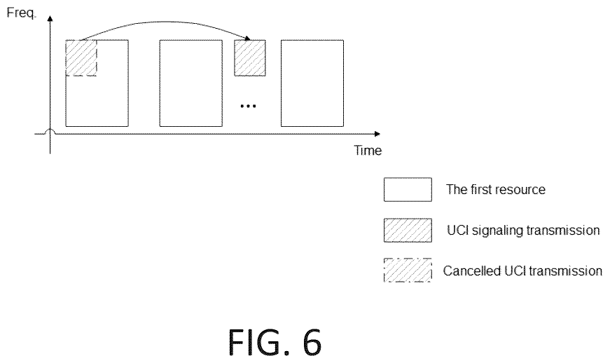

FIG. 7 shows a flowchart of a method according to an embodiment of the present disclosure. The method shown in FIG. 7 may be used in a network device (e.g., UE) and comprises the following steps:

Step 701: Receive, from a network node, a control signaling associated with resource configuration information.

Step 702: Determine a time and frequency location of one or more first data transmission resources according to the resource configuration information based on a first condition.

Step 703: Transmit, to the network node, data and/or a UCI signaling in the one or more first data transmission resources.

In an embodiment, the first data transmission resources (e.g., TBs on the PUSCH) comprise first resources and/or second resources.

In an embodiment, the data is transmitted on the first resources.

In an embodiment, the data is transmitted on the first resource, while the UCI signaling is transmitted on the second resources.

In an embodiment, the data and the UCI signaling are transmitted on the second resources.

In an embodiment, the uplink control signaling comprises at least one of: HARQ-ACK information, a CSI report, activation/deactivation indication information, traffic latency information, buffer status information, traffic reliability information, remaining time for transmission information or packet arrival information.

In an embodiment, (the UCI signaling comprising) the activation/deactivation indication information is for activating/deactivating one or more first data transmission resources in one multiplexing configuration. For example, the activation/deactivation indication information is used for indicating that one or more first data transmission resources are available or unavailable. The available (activated) first data transmission resources are used for transmitting data and/or multiplexing the UCI signaling. The unavailable (deactivated) first data transmission resources are not used for transmitting the data and/or multiplexing the UCI signaling.

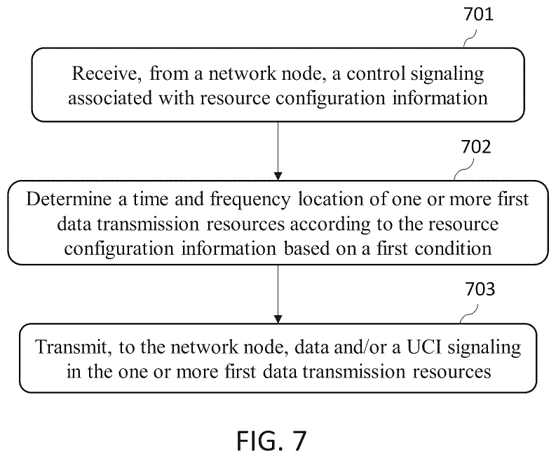

In an embodiment, (the UCI signaling comprising) the traffic latency information is for reporting a latency requirement to the gNB, wherein the latency requirement is the maximum time for (completing/finishing) a traffic packet transmission (e.g., packet latency requirement in FIG. 8). For example, the latency requirement may be 10 microseconds (ms), 15 ms or 30 ms.

In an embodiment, (the UCI signaling comprising) the buffer status information is for reporting a traffic packet size to the gNB (e.g., 100 Bytes, 62500 Bytes, 93750 Bytes).

In an embodiment, (the UCI signaling comprising) the traffic reliability information is for reporting a reliability requirement to the gNB, wherein the reliability requirement is the maximum packet error ratio of a transport block in a traffic packet (e.g., 1%, 0.1%, 0.01%).

In an embodiment, (the UCI signaling comprising) the packet arrival information is for reporting, to the gNB, an arrival time of one packet (e.g., packet arrival time shown in FIG. 8).

In an embodiment, (the UCI signaling comprising) the remaining time for transmission information is for reporting a residual/remaining time for a packet transmission to gNB, wherein the residual time may be a time range between a current time and an packet completion time of one packet (which is the latency requirement of the packet after the arrival time of the packet) as shown in FIG. 8.

In some embodiments, the control signaling may comprise at least one of a high layer signaling or a downlink control information (DCI) signaling. For example, the high layer signaling may comprise a radio resource control (RRC) signaling (e.g., ConfiguredGrantConfig) and/or a media access control (MAC) control element (CE). The DCI signaling may be (configured) for a resource activation, including, e.g., DCI format 0_0, DCI format 0_1 or DCI format 0_2.

In some embodiments, the resource configuration information includes at least one of:
a plurality of multiplexing configurations,
Time domain resource assignment information,
Frequency domain resource assignment information,
Offset information.
Repetition information, or
Priority information

In an embodiment, the plurality of multiplexing configurations are used for providing candidate resources for data transmissions and/or UCI signaling transmissions.

In an embodiment, the time domain resource assignment information is a parameter timeDomainAllocation in an RRC signaling ConfiguredGrantConfig, or a row index of PUSCH-TimeDomainResourceAllocationList indicated by a DCI signaling comprising a field “Time domain resource assignment”.

In an embodiment, a frequency domain resource information is a parameter frequencydomainAllocation in the RRC signaling ConfiguredGrantConfig, or a value indicated by a DCI signaling comprising a field “frequency domain resource assignment”.

In an embodiment, the multiplexing configuration(s) is (are) determined as the following embodiments.

Note that the multiplexing configurations share time/frequency domain resources means that the multiplexing configuration have the time/frequency domain locations of one or more first data transmission resources belong to different multiplexing configurations are same.

In addition, orthogonal time/frequency domain resources means that time/frequency domain locations of one or more first transmission resources belonging to different multiplexing configurations do not overlap with each other.

In an embodiment of Type-1 configured grant (CG), a CG set may be configured for associating different configurations in an RRC signaling PUSCH-config or a ConfiguredGrantConfig. The CG set is determined by, for example, a parameter CGset, in which the CG configuration indices are included. In this embodiment, the timeDomainAllocation and frequencydomainAllocation in ConfiguredGrantConfig are used for determining the time domain locations and the frequency domain locations of the CG configurations in the CG set.

For example, there are three CG configurations with indices 1, 2, and 3. The CGset can be expressed as {1, 2, 3}. The timeDomainAllocation and frequencydoaminAllocation can be used for determining the time domain locations and the frequency domain locations of the CG configurations in the CG set {1, 2, 3}. In an embodiment, the timeDomainAllocation is an integer sequence, {4, 7, 15}, which is used to determine the time domain of CG configurations in CG set one by one. That is 4 is for the CG configuration 1, 7 is for the CG configuration 2, and 15 is for the CG configuration 3. The value in the sequence denotes a start and length indicator value (SLIV), which is used to indicate a starting symbol and a length of symbols and to determine a symbol range.

In an embodiment, the frequencyDomainAllocation is a bitmap sequence, {1001, 0100, 0010}, which is used to determine the frequency domain of the CG configurations in the CG set one by one, i.e., ‘1001’ is for the CG configuration 1, ‘0100’ is for the CG configuration 2, and ‘0010’ is for CG configuration 3. The bit in each bitmap indicates the corresponding resource block or resource block group is available or unavailable, wherein ‘1’ denotes available and ‘0’ denotes unavailable.

In an embodiment of Type-1 configured grant, each CG configuration is configured separately. In this embodiment, the time and frequency domain locations of different CG configurations are shared, which implies that the timeDomainAllocation, frequencyDomainAllocation and timeDomainOffset are the same among the CG configurations.

In an embodiment of Type-2 configured grant, a CG set is configured for associating different CG configurations in an RRC signaling PUSCH-config or ConfiguredGrantConfig. The CG set is determined by, for example, a parameter CGset, in which the CG configuration indices are included. As a result, activation DCI are used for activating the CG configurations in the CG set, and determining the time domain locations and the frequency domain locations of the CG configurations in the CG set.

For example, there are three CG configurations with indices 1, 2, and 3 (i.e., CG configuration 1, CG configuration 2 and CG configuration 3). The CGset can be expressed as {1, 2, 3}. The “HARQ process number” in the activation DCI may be reused to indicate one of CG sets is activated/used. (e.g., Set 1 {1, 2, 3}, Set 2 {4, 5, 6}, “HARQ Process number” field indicating “0001”, represents that the first CG set, i.e., Set 1 is selected), while the “time domain resource assignment” field and “frequency domain resource assignment” field in the activation DCI may be used for determining the time domain locations and frequency domain locations of the CG configurations in the CGset {1, 2, 3}.

In an embodiment, the “time domain resource assignment” field indicates one of rows in PUSCH-TimeDomainResourceAllocationList, wherein the selected row includes three SLIVs {4, 7, 15}which is used to determine the time domain of CG configurations in the CG set one by one. That is 4 is for the CG configuration 1, 7 is for the CG configuration 2, and 15 is for the CG configuration 3.

In an embodiment, the “frequency domain resource assignment” field indicates a bitmap sequence, {1001, 0100, 0010}which is used to determine the frequency domain of CG configurations in the CG set one by one. In this embodiment, ‘1001’ is for the CG configuration 1, ‘0100’ is for the CG configuration 2, and ‘0010’ is for the CG configuration 3. The bit in each bitmap indicates that the corresponding resource block or resource block group is available or unavailable, e.g., ‘1’ for available and ‘0’ for unavailable.

In an embodiment, the “frequency domain resource assignment” field indicates an integer sequence {58, 60, 102}, wherein integers in the integer sequence is used to determine the frequency domain of the CG configurations in CG set one by one. In this embodiment, 58 is for the CG configuration 1, 60 is for the CG configuration 2, and 102 for CG configuration 3. The value in the sequence denotes a resource indicator value (RIV), which is used to indicate a starting resource block or resource block group and a length of occupied resources block or resource block group and to determine a resource block range.

In an embodiment of Type-2 CG, each CG configuration is configured separately. In this embodiment, the time and frequency domain locations of different CG configurations should be shared, which implies that the “time domain resource assignment” field and the “frequency domain resource assignment” field are same among the CG configurations.

In an embodiment, the time and frequency domain location is determined as the following four patterns:

1) Shared time domain resource assignment and orthogonal frequency domain resource assignment, which may be configured by:
Type 1 CG: The timeDomainAllocation is an integer value and the frequencyDomainAllocation is a bitmap sequence, where AND results of each pair of the bitmaps in the bitmap sequence are all zeros.
Type 2 CG: the “time domain resource assignment” field indicates one of rows, wherein the selected row has only one SLIV and the “frequency domain resource assignment” field indicates a RIV sequence or a bitmap sequence, where the resource block ranges or resource block group ranges determined by the RIVs the CG configurations do not overlap each other or the AND results of each pair of bitmaps in the bitmap sequence are all zeros.

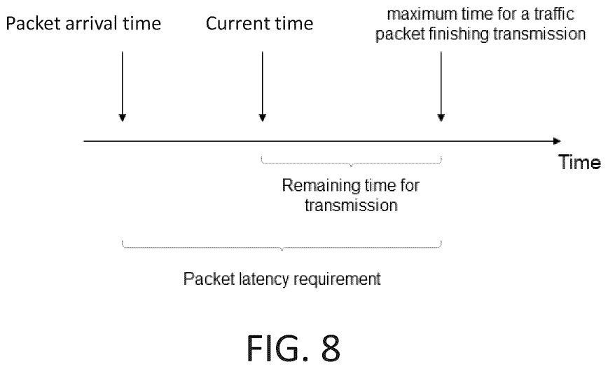

FIG. 9 shows a schematic diagram of the shared time domain resource assignment and orthogonal frequency domain resource assignment according to an embodiment of the present disclosure. In FIG. 9, the CG PUSCH for configuration 1 and the CG PUSCH for configuration 2 share the same time domain resources and have the orthogonal frequency domain resources.

2) Shared frequency domain resource assignment and orthogonal time domain resource assignment, which may be configured by:

Type 1 CG: The timeDomainAllocation is a SLIV sequence, where symbol ranges indicated by the SLIVs for different CG configurations do not overlap each other, while the frequencyDomainAllocation is a bitmap.

Type 2 CG: The “time domain resource assignment” field indicates one of rows, wherein the selected row has a plurality of SLIVs and the symbol ranges determined by the SLIVs for different CG configurations do not overlap each other. The “frequency domain resource assignment” field indicates a RIV or a bitmap.

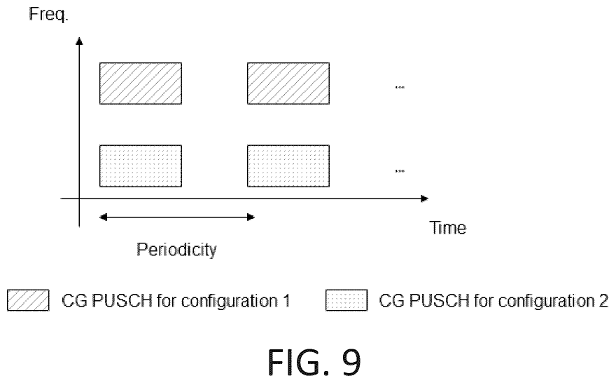

FIG. 10 shows a schematic diagram of the shared frequency domain resource assignment and orthogonal time domain resource assignment according to an embodiment of the present disclosure. As shown in FIG. 10, the CG PUSCH for configuration 1 and the CG PUSCH for configuration 2 share the same frequency domain resources and have the orthogonal time domain resources.

3) Orthogonal time and frequency resource assignment, which may be configured by:
Type 1 CG: In an embodiment, the timeDomainAllocation is an SLIV sequence where symbol ranges indicated by the SLIVs for different CG configurations are not overlapped with each other, while the frequencyDomainAllocation is a bitmap sequence, where the AND results of each pair of bitmaps in the bitmap sequence are all zeros. As an alternative, the timeDomainAllocation is an SLIV sequence, where symbol ranges indicated by the SLIVs for different CG configurations may partly overlap, while the frequencyDomainAllocation is a bitmap sequence, where the AND results of each pair of bitmaps in the bitmap sequence are not all zeros.
Type 2 CG: In an embodiment, the “time domain resource assignment” field indicates one of rows, wherein the selected row has more than one SLIVs and the symbol ranges determined by the SLIVs for different CG configurations do not overlap each other, and the “frequency domain resource assignment” field indicates a RIV sequence or a bitmap sequence, where resource block ranges or resource block group ranges determined by the RIVs for different CG configurations do not overlap each other or the AND results of each pair of bitmaps in the bitmap sequence are all zeros. As an alternative, The “time domain resource assignment” field indicates one of rows, wherein the selected row has a plurality of SLIVs for different CG configurations and the symbol ranges determined by the SLIVs partly overlaps, or the “frequency domain resource assignment” field indicates a RIV sequence or a bitmap sequence, where resource block ranges or resource block group ranges determined by RIVs for different CG configurations partly overlap or the AND results of each pair of bitmap in the bitmap sequence are not all zeros.

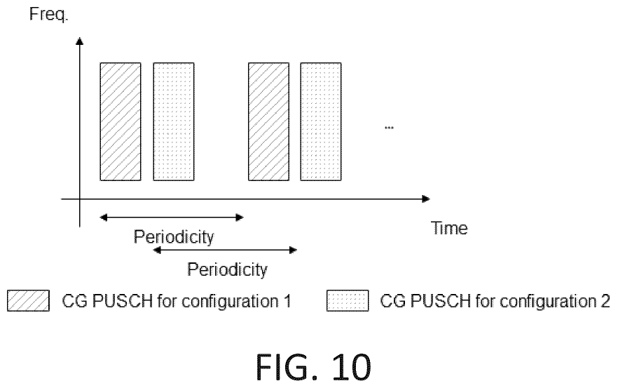

FIG. 11 shows schematic diagrams of the orthogonal time and frequency resource assignment according to an embodiment of the present disclosure. In FIG. 11 (a), the time domain resources of the CG PUSCH for configuration 1 overlap those of the CG PUSCH for configurations 2 and the frequency domain resources of the CG PUSCH for configuration 1 and the CG PUSCH for configuration 2 are orthogonal. In FIG. 11 (b), the frequency domain resources of the CG PUSCH for configuration 1 overlap those of the CG PUSCH for configurations 2 and the time domain resources of the CG PUSCH for configuration 1 and the CG PUSCH for configuration 2 are orthogonal. In FIG. 11 (c), both the time domain resources and the frequency domain resources of the CG PUSCH for configuration 1 and the CG PUSCH for configuration 2 are orthogonal.

4) Shared time and frequency resource assignment, which may be configured by:
Type 1 CG: The timeDomainAllocation is a integer value, while the frequencyDomainAllocation is a bitmap.
Type 2 CG: The “time domain resource assignment” field indicates one of rows, wherein the selected row has only one SLIV, while the “frequency domain resource assignment” field indicate a RIV or a bitmap.

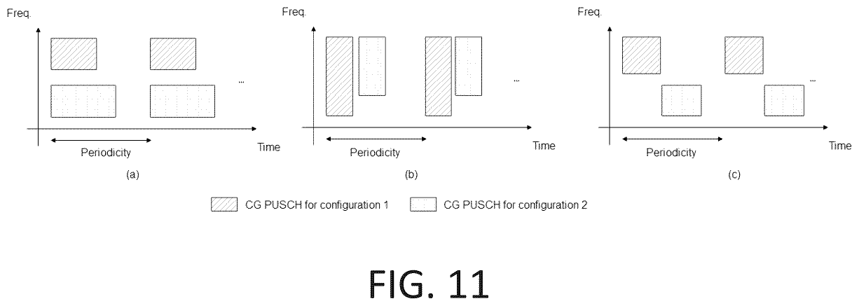

FIG. 12 shows a schematic diagram of the Shared time and frequency resource assignment according to an embodiment of the present disclosure. In FIG. 12, the CG PUSCH for configuration 1 and the CG PUSCH for configuration 2 share the same time domain resources and the same frequency domain resources.

In an embodiment, different multiplexing configurations have/indicate different first resources and second resources in time and frequency domain.

In an embodiment, the time domain locations of the first resources for one multiplexing configuration are different from those of the first resources for another multiplexing configuration. That is the SLIV values of the first resources for these two multiplexing configurations are different.

In an embodiment, the frequency domain locations of the first resources for one multiplexing configuration are different from those of the first resources for another multiplexing configuration. For example, the RIV values or the bitmap corresponding to the first resources for these two multiplexing configurations are different.

In an embodiment, both the time and frequency domain locations of the first resources for one multiplexing configuration are different from those of the first resources for another multiplexing configuration. For instance, the SLIV values and the RIV values or the bitmap corresponding to the first resources for these two multiplexing configurations are different.

In an embodiment, the time domain locations of the second resources for one multiplexing configuration are different from those of the second resources for another multiplexing configuration, implying that the SLIV values for the second resources associated with these two multiplexing configurations may be different.

In an embodiment, the frequency domain locations of the second resources for one multiplexing configuration are different from those of second resource for another multiplexing configuration, which may indicate that the RIV values or the bitmap corresponding to the second resources for these two multiplexing configurations are different.

In an embodiment, both the time and frequency domain locations of the second resources for one multiplexing configuration are different from those of second resource for another multiplexing configuration, implying that the SLIV values and the RIV values or the bitmap corresponding to the second resources for these two multiplexing configurations are different.

In some embodiments, the time and/or frequency domain locations of the first resources and the second resources are determined based on the resource configuration information. Note that the time and/or frequency domain locations of the first resources and the second resources may be determined further based on other signaling/information (e.g., beta offset).

In an embodiment, the offset information is beta offset information for the UCI signaling. For example, the offset information may be used to determine a bit length of UCI signaling.

In an embodiment of multiple multiplexing configurations being configured, the offset information for different multiplexing configurations is determined as the following:

All multiplexing configurations share a same value indicated by a parameter CG-UCI-OnPUSCH. In this case, the multiplexing configurations all belong to one CG set.

Each multiplexing configuration has its own offset value indicated by the parameter CG-UCI-OnPUSCH.

In an embodiment, the repetition information is used to determine repetition times of a single transport block (see, e.g., FIG. 5).

In an embodiment, the priority information indicates a priority associated with the first resources and/or the second resources.

In some embodiments, the first condition is associated with at least one of:
an existence situation of the UCI signaling,
an overlapping situation between PUCCH resources for the UCI signaling and the one or more first data transmission resources,
repetition information associated with the number of times of repeating a transport block of the data, or
priority information associated with the transmission priority of the data or the UCI signaling.

In an embodiment, the existence situation of UCI signaling indicates that whether there is UCI signaling transmission in this slot, symbol or millisecond.

In an embodiment, the overlapping situation between the PUCCH resources for the UCI signaling and the one or more first data transmission resources indicates that whether there are overlapped symbols between the PUCCH resource and the first data transmission resource.

In an embodiment, determining the first resources and/or the second resources based on the first condition includes at least one of

If the existence situation of the UCI signaling indicates that there is no UCI signaling transmission, then the first resources of the multiplexing configurations without second resources are determined for transmitting data.

If the existence situation of the UCI signaling indicates that there are one or more UCI signaling transmissions, the first condition is further based on the overlapping situation between the PUCCH resources for the UCI signaling and the one or more first data transmission resources:

2.1) If the overlapping situation indicates that the PUCCH resources for the UCI signaling do not overlap the one or more first data transmission resources, the first resources of the multiplexing configurations without second resources are determined for transmitting the data.

2.2) If the overlapping situation is/indicates that the PUCCH resources for the UCI signaling overlap the one or more first data transmission resources, there are two cases:

2.2.1) the second resources of one of the plurality of multiplexing configurations are determined for transmitting data and UCI signaling in the case that the data and the UCI signaling are transmitted in the second resources and only data is transmitted in the first resources.

2.2.2) the first resources and the second resources of one of the plurality of multiplexing configurations are determined for respectively transmitting the data and the UCI signaling in the case that the data is transmitted in the first resources while the UCI signaling is transmitted in the second resource.

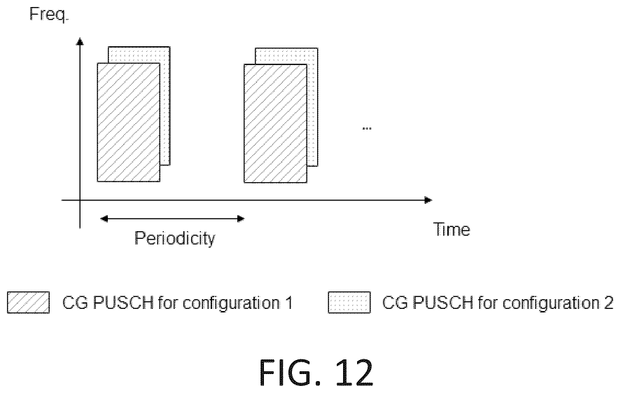

For example, FIG. 13 shows an embodiment of 3 multiplexing configurations being configured. In this embodiment, the first multiplexing configuration only consists of more than one first resources, while the second multiplexing configuration and the third multiplexing configuration consist of more than one first resources and more than one second resources with different time and frequency domain occupations.

In the embodiment shown in FIG. 13, when the UCI signaling exists and the time domain location of the PUCCH resources for the UCI signaling transmission overlaps the time domain location of at least one of the first resources means that the UCI signaling is multiplexed in the second resources. For the data transmission in the 1-st occasion, if the value of offset information is small (e.g., beta offset is larger than 0.0 and less than 5.0), the multiplexing configuration is switched to the multiplexing configuration 2. Hence, the data is transmitted in the first resources of the multiplexing configuration 2, while the UCI signaling is transmitted in the second resources of the multiplexing configuration 2.

For the data transmission in the 2-nd occasion, if the value of offset is large (e.g., beta offset is larger than 5.0), the multiplexing configuration is switched to the multiplexing configuration 3. Hence, the data is transmitted in the first resources of the multiplexing configuration 3, while UCI signaling is transmitted in the second resources of the multiplexing configuration 3.

In the 3-rd occasion in the FIG. 13, the configuration is switched to the multiplexing configuration 1 because there is no UCI signaling transmission or the PUCCH resources for the UCI signaling do not overlap the first resources. Hence, the data is transmitted in the first resources of the multiplexing configuration 1.

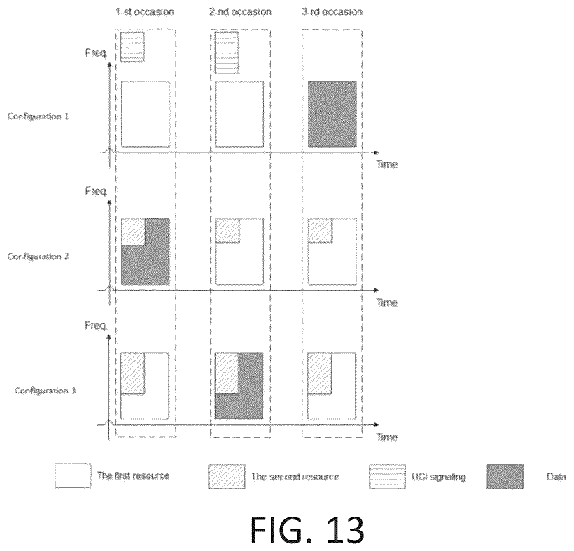

FIG. 14 shows a schematic diagram of transmissions on the PUSCH according to an embodiment of the present disclosure. In FIG. 14, 3 multiplexing configurations are configured.

Note that the embodiment shown in FIG. 14 has different definitions on the first resources and the second resources. In the embodiment shown in FIG. 14, the first resources are the resources (e.g., TB(s) on the CG PUSCH) configured only for transmitting the data and the second resources represent the resources configured for transmitting both the data and the UCI signaling. The second resources in different (multiplexing) configurations may have different resources (i.e., resources with different time domain positions and/or different frequency positions) for transmitting UCI signaling and/or data.

In the embodiment shown in FIG. 14, the UCI signaling exists and the PUCCH resources for the UCI signaling transmission overlap at least one of the first data transmission resources in the 1-st occasion. For the data transmission in the 1-st occasion, if the value of offset information is small (e.g., beta offset is larger than 0.0 and less than 5.0), the multiplexing configuration is switched to the multiplexing configuration 2. The data and the UCI signaling are transmitted in the second resources of the multiplexing configuration 2.

In the 2-nd occasion, the UCI signaling exists and the PUCCH resources for the UCI signaling transmission overlap at least one of the first data transmission resources. In this embodiment, the value of offset information becomes large (e.g., the beta offset is larger than 5.0), the used multiplexing configuration is switched to the multiplexing configuration 3. Hence, the data and the UCI signaling are transmitted in the second resources of the multiplexing configuration 3.

In the 3-rd occasion in the FIG. 14, the configuration is switched to the multiplexing configuration 1 because there is no UCI signaling transmission or the PUCCH resources for the UCI signaling do not overlap the first data transmission resources. Hence, the data is transmitted in the first resources of the multiplexing configuration 1.

3) If the overlapping situation indicates that the PUCCH resources for UCI signaling do not overlap the one or more first data transmission resources, the first resources and K third resources of one of a plurality of multiplexing configurations are determined for transmitting the data, wherein the data transmitted on the third resources is a duplication of the data transmitted on the first resource and K is a positive integer determined by at least the repetition information in the resource configuration information.

In an embodiment, the duplication of the data is the transport block with the same redundancy version as that transmitted in the first resource.

In an embodiment, the duplication of the data is the transport block with the different redundancy versions from that of the transport block transmitted in the first resources.

In an embodiment, the first resources and the K third resources are consecutive resources in the one or more data transmission resources in a multiplexing configuration.

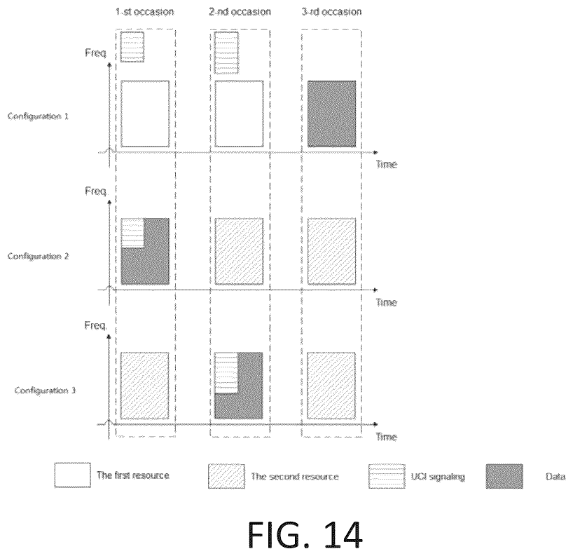

For example, there are three transport blocks TB1, TB2 and TB3 in FIG. 15. In this embodiment, K is set to 2. In FIG. 15, the PUCCH resources for the UCI signaling overlap with the first data transmission resources for transmitting TB1 and TB3 respectively. Under such conditions, the TB1 and TB3 are transmitted repeatedly in K=2 consecutive resources (a first resource and a third resource), while TB2 is transmitted in one first resource.

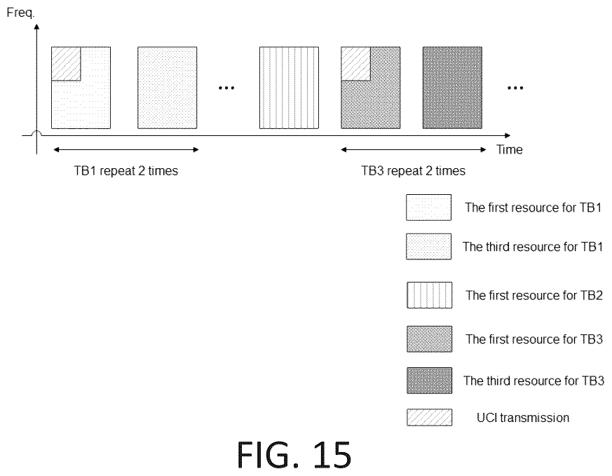

In an embodiment shown in FIG. 16, there are three transport blocks TB1, TB2 and TB3 and K is set to 2. In this embodiment, the PUCCH resources for the UCI signaling overlap the first data transmission resources for transmitting the TB1 and TB3 respectively. As shown in FIG. 16, the TB1 and TB3 are transmitted repeatedly in K=2 resources (i.e., a first resource and a third resource), while TB2 is transmitted in one first resource. Note that, in FIG. 16, the repetitions of TB1 and TB3 are transmitted after initial transmissions of the TB1, TB2 and TB3 complete.

In an embodiment, the repetition is terminated when the data is repeated in the K third resources, wherein K (e.g., indicated by the repetition information) is determined by an RRC signaling. For example, K is determined by a parameter repK or repK-r17 in ConfiguredGrantConfig.

In an embodiment, the repetition is terminated when the there is no third resource for data transmissions.

In an embodiment, when the UCI signaling is transmitted in the PUCCH resource, the data is not repeated in the first resources of one or more first data transmission resources.

4) If PUCCH resources for the UCI signaling overlap the one or more first data transmission resources, and the data has a priority higher than a priority of the UCI signaling (e.g., the data has a priority ‘2’ and the UCI signaling has a priority ‘0’) the first resources are determined for transmitting data and the second resources for transmitting UCI are canceled. In this case, a second data transmission resource is determined for transmitting the UCI signaling.

In an embodiment, the second data transmission resource is at least one of: a PUCCH resource or a PUSCH resource.

5) If the PUCCH resources for the UCI signaling transmission do not overlap (the time domain location of) any one of the first data transmission resources, the UCI signaling with low priority is transmitted in the PUCCH resources, while the data with high priority is transmitted in the first resources in one or more first data transmission resources.

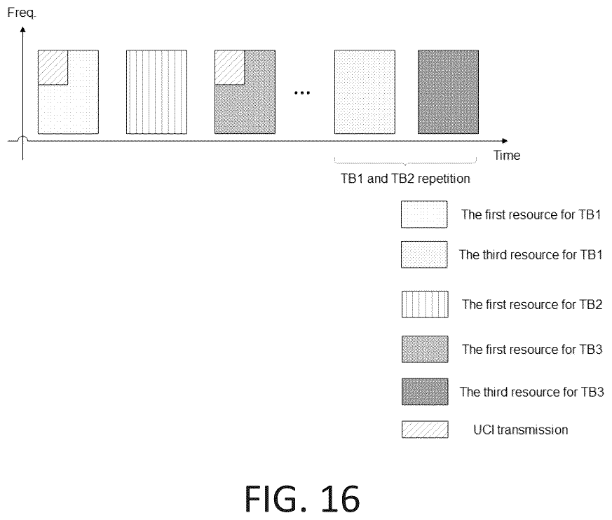

FIG. 17 shows a flowchart of a method according to an embodiment of the present disclosure. The method shown in FIG. 17 may be used in a network node (e.g., base station, gNB) and comprises the following steps:

Step 1701: Transmit, to a network device, a control signaling comprising resource configuration information associated with one or more first data transmission resources.

Step 1702: Determine a time and frequency location of one or more first data transmission resources according to the resource configuration information based on a first condition

Step 1703: Receive, from the network device, data and/or a UCI in the one or more first data transmission resources.

In an embodiment, the first data transmission resources (e.g., TBs on the PUSCH) comprise first resources and/or second resources.

In an embodiment, the data is received on the first resources.

In an embodiment, the data is received on the first resources and the UCI signaling is received on the second resources.

In an embodiment, the data and the UCI signaling are received on the second resources.

The details of the resource configuration information can be referred to the aforementioned embodiments.

Similarly, the details of the first condition can also be referred to the aforementioned embodiments.

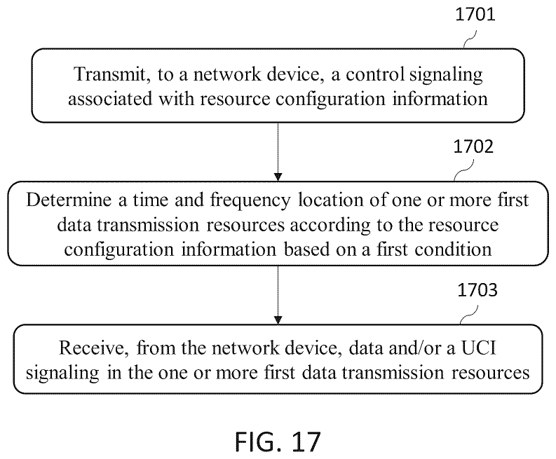

FIG. 18 relates to a schematic diagram of a wireless terminal 180 according to an embodiment of the present disclosure. The wireless terminal 180 may be a user equipment (UE), a mobile phone, a network device, a laptop, a tablet computer, an electronic book or a portable computer system and is not limited herein. The wireless terminal 180 may include a processor 1800 such as a microprocessor or Application Specific Integrated Circuit (ASIC), a storage unit 1810 and a communication unit 1820. The storage unit 1810 may be any data storage device that stores a program code 1812, which is accessed and executed by the processor 1800. Embodiments of the storage unit 1810 include but are not limited to a subscriber identity module (SIM), read-only memory (ROM), flash memory, random-access memory (RAM), hard-disk, and optical data storage device. The communication unit 1820 may a transceiver and is used to transmit and receive signals (e.g., messages or packets) according to processing results of the processor 1800. In an embodiment, the communication unit 1820 transmits and receives the signals via at least one antenna 1822 shown in FIG. 18.

In an embodiment, the storage unit 1810 and the program code 1812 may be omitted and the processor 1800 may include a storage unit with stored program code.

The processor 1800 may implement any one of the steps in exemplified embodiments on the wireless terminal 180, e.g., by executing the program code 1812.

The communication unit 1820 may be a transceiver. The communication unit 1820 may as an alternative or in addition be combining a transmitting unit and a receiving unit configured to transmit and to receive, respectively, signals to and from a wireless network node (e.g., a base station).

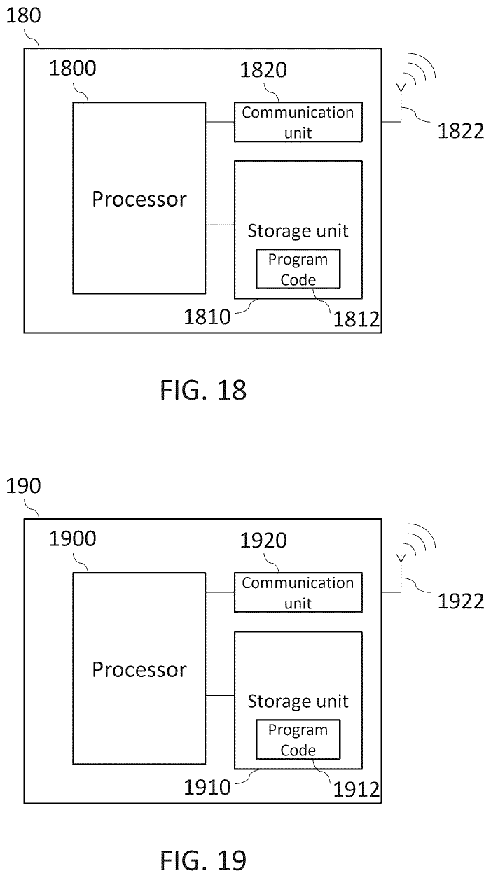

FIG. 19 relates to a schematic diagram of a wireless network node 190 according to an embodiment of the present disclosure. The wireless network node 190 may be a satellite, a base station (BS), a network entity, a Mobility Management Entity (MME), Serving Gateway (S-GW), Packet Data Network (PDN) Gateway (P-GW), a radio access network (RAN) node, a next generation RAN (NG-RAN) node, a gNB, an eNB, a gNB central unit (gNB-CU), a gNB distributed unit (gNB-DU) a data network, a core network or a Radio Network Controller (RNC), and is not limited herein. In addition, the wireless network node 190 may comprise (perform) at least one network function such as an access and mobility management function (AMF), a session management function (SMF), a user place function (UPF), a policy control function (PCF), an application function (AF), etc. The wireless network node 190 may include a processor 1900 such as a microprocessor or ASIC, a storage unit 1910 and a communication unit 1920. The storage unit 1910 may be any data storage device that stores a program code 1912, which is accessed and executed by the processor 1900. Examples of the storage unit 1910 include but are not limited to a SIM, ROM, flash memory, RAM, hard-disk, and optical data storage device. The communication unit 1920 may be a transceiver and is used to transmit and receive signals (e.g., messages or packets) according to processing results of the processor 1900. In an example, the communication unit 1920 transmits and receives the signals via at least one antenna 1922 shown in FIG. 19.

In an embodiment, the storage unit 1910 and the program code 1912 may be omitted. The processor 1900 may include a storage unit with stored program code.

The processor 1900 may implement any steps described in exemplified embodiments on the wireless network node 190, e.g., via executing the program code 1912.

The communication unit 1920 may be a transceiver. The communication unit 1920 may as an alternative or in addition be combining a transmitting unit and a receiving unit configured to transmit and to receive, respectively, signals to and from a wireless terminal (e.g., a user equipment or another wireless network node).

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any one of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any one of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A skilled person would further appreciate that any one of the various illustrative logical blocks, units, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software unit”), or any combination of these techniques.

To clearly illustrate this interchangeability of hardware, firmware and software, various illustrative components, blocks, units, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, device, component, circuit, structure, machine, unit, etc. can be configured to perform one or more of the functions described herein. The term “configured to” or “configured for” as used herein with respect to a specified operation or function refers to a processor, device, component, circuit, structure, machine, unit, etc. that is physically constructed, programmed and/or arranged to perform the specified operation or function.

Furthermore, a skilled person would understand that various illustrative logical blocks, units, devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, units, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein. If implemented in software, the functions can be stored as one or more instructions or code on a computer-readable medium. Thus, the steps of a method or algorithm disclosed herein can be implemented as software stored on a computer-readable medium.

Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “unit” as used herein, refers to software, firmware, hardware, and any combination of these elements for performing the associated functions described herein. Additionally, for purpose of discussion, the various units are described as discrete units; however, as would be apparent to one of ordinary skill in the art, two or more units may be combined to form a single unit that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of the claims. Thus, the disclosure is not intended to be limited to the implementations shown herein, but is to be accorded the widest scope consistent with the novel features and principles disclosed herein, as recited in the claims below.

1. A wireless communication method for use in a wireless terminal, the method comprising:
receiving, from a wireless network node, a control signaling comprising resource configuration information associated with one or more first data transmission resources,
determining first resources in the one of a plurality of the first data transmission resources and/or second resources in the one of the plurality of the first data transmission resources based on a first condition, and
transmitting, to the wireless network node, at least one of:
data on the first resources,
an uplink control information, UCI, signaling on the second resources, or
data and an uplink control information, UCI, signaling on the second resources.

2. The wireless communication method of claim 1, wherein the UCI signaling comprises at least one of:
a hybrid automatic repeat request acknowledge,
a channel state information report,
activation/deactivation indication information, associated with the first data transmission resources,
traffic latency information, associated with a maximum time of a packet transmission,
buffer status information, associated with a size of a packet,
traffic reliability information, associated with a maximum packet error ratio of a transport block in a packet,
remaining time for transmission information, associated with a remaining time of a packet transmission, or
packet arrival information, associated with an arrival time of a packet.

3. The wireless communication method of claim 1, wherein the control signaling includes at least one of: a radio resource control signaling, a media access control element or a downlink control information signaling.

4. The wireless communication method of claim 1, wherein the first data transmission resources are configured based on an uplink configured grant, the data is transmitted on the first resources and the UCI signaling is transmitted on the second resources.

5. (canceled)

6. The wireless communication method of claim 1, wherein the resource configuration information includes at least one of:
a plurality of multiplexing configurations, wherein each multiplexing configuration indicates the one or more first data transmission resources comprising the first resources and/or second resources,
time domain resource assignment information for at least one of the first resources or the second resources,
frequency domain resource assignment information for at least one of the first resources or the second resources,
offset information used for determining a time and frequency location of the second resources,
repetition information, associated with a number of times of repeating a transport block of the data, or
priority information, associated with a transmission priority of the data or the UCI signaling.

7. The wireless communication method of claim 6, wherein the plurality of multiplexing configurations are determined as at least one of the following: shared time domain resource assignment and orthogonal frequency domain resource assignment; shared frequency domain resource assignment and orthogonal time domain resource assignment; both orthogonal time and frequency resource assignment; both shared time and frequency resource assignment.

8-11. (canceled)

12. The wireless communication method of claim 1, wherein determining the first resources in the one of the plurality of the first data transmission resources and/or the second resources in the one of the plurality of the first data transmission resources based on the first condition includes at least one of:
if there is no UCI signaling transmission, the first resources of one of the multiplexing configurations which does not have the second resources are determined for transmitting the data,
if there are one or more UCI signaling transmissions and physical uplink control channel, PUCCH, resources for the UCI signaling do not overlap the one or more first data transmission resources, the first resources of one of a plurality of multiplexing configurations which does not have the second resources are determined for transmitting the data,
if there are one or more UCI signaling transmissions and PUCCH resources for the UCI signaling overlap the one or more first data transmission resources, the second resources of one of a plurality of multiplexing configurations are determined for the first data transmission and UCI signaling transmission,
if there are one or more UCI signaling transmissions and PUCCH resources for the UCI signaling overlaps the one or more first data transmission resources, the first resources and the second resources of one of a plurality of multiplexing configurations are determined for respectively transmitting the data and the UCI signaling,
if there are one or more UCI signaling transmissions, the first resources and at least one third resource of one of a plurality of multiplexing configurations are determined for transmitting the data, wherein the data transmitted on the third resource is a duplication of the data transmitted on the first resources, or
if PUCCH resources for the UCI signaling overlap the one or more first data transmission resources and the data has a priority higher than a priority of the UCI signaling, the first resources of one of a plurality of multiplexing configurations are determined for transmitting the data and the second resources of the same multiplexing configuration are canceled.

13. The wireless communication method of claim 12, wherein the first resources and the at least one third resource are consecutive resources in the one or more data transmission resources; or the first resources and the at least one third resource are inconsecutive resources in the one or more data transmission resources.

14. (canceled)

15. The wireless communication method of claim 12, wherein the first resources of one of the plurality of multiplexing configurations are determined for transmitting the data and the second resources of the same multiplexing configuration are canceled, and
wherein priority information in the resource configuration information indicates that data transmissions have a higher priority than UCI signaling transmissions.

16. (canceled)

17. (canceled)

18. A wireless communication method for use in a wireless network node, the method comprising:
transmitting, to a wireless terminal, a control signaling comprising resource configuration information associated with one or more first data transmission resources,
determining first resources in the one of a plurality of the first data transmission resources and/or second resources in the one of the plurality of the first data transmission resources based on a first condition, and
receiving, from the wireless terminal, at least one of:
data on the first resources,
an uplink control information, UCI, signaling on the second resources, or
data and an uplink control information, UCI, signaling on the second resources.

19. The wireless communication method of claim 18, wherein the UCI signaling comprises at least one of:
a hybrid automatic repeat request acknowledge,
a channel state information report,
activation/deactivation indication information, associated with the first data transmission resources,
traffic latency information, associated with a maximum time of a packet transmission,
buffer status information, associated with a size of a packet,
traffic reliability information, associated with a maximum packet error ratio of a transport block in a packet,
remaining time for transmission information, associated with a remaining time of a packet transmission, or
packet arrival information, associated with an arrival time of a packet.

20. The wireless communication method of claim 18, wherein the control signaling includes at least one of: a radio resource control signaling, a media access control element or a downlink control information signaling.

21. The wireless communication method of claim 18, wherein the first data transmission resources are configured based on an uplink configured grant, the data is received on the first resources and the UCI signaling is received on the second resources.

22. (canceled)

23. The wireless communication method of claim 18, wherein the resource configuration information includes at least one of:
a plurality of multiplexing configurations, wherein each multiplexing configuration indicates the one or more first data transmission resources comprising the first resources and/or second resources,
time domain resource assignment information for at least one of the first resources or the second resources,
frequency domain resource assignment information for at least one of the first resources or the second resources,
offset information used for determining a time and frequency location of the second resources,
repetition information, associated with a number of times of repeating a transport block of the data, or
priority information, associated with a transmission priority of the data or the UCI signaling.

24. The wireless communication method of claim 23, wherein the plurality of multiplexing configurations are determined as at least one of the following: shared time domain resource assignment and orthogonal frequency domain resource assignment; shared frequency domain resource assignment and orthogonal time domain resource assignment; both orthogonal time and frequency resource assignment; both shared time and frequency resource assignment.

25-28. (canceled)

29. The wireless communication method of claim 18, wherein determining the first resources in the one of the plurality of the first data transmission resources and/or the second resources in the one of the plurality of the first data transmission resources based on the first condition includes at least one of:
if there is no UCI signaling transmission, the first resources of one of the multiplexing configurations which does not have the second resources are determined for receiving the data,
if there are one or more UCI signaling transmissions and physical uplink control channel, PUCCH, resources for the UCI signaling do not overlap the one or more first data transmission resources, the first resources of one of a plurality of multiplexing configurations which does not have the second resources are determined for receiving the data,
if there are one or more UCI signaling transmissions and PUCCH resources for the UCI signaling overlap the one or more first data transmission resources, the second resources of one of a plurality of multiplexing configurations are determined for the first data reception and UCI signaling reception,
if there are one or more UCI signaling transmissions and PUCCH resources for the UCI signaling overlaps the one or more first data transmission resources, the first resources and the second resources of one of a plurality of multiplexing configurations are determined for respectively receiving the data and the UCI signaling,
if there are one or more UCI signaling transmissions, the first resources and at least one third resource of one of a plurality of multiplexing configurations are determined for receiving the data, wherein the data received on the third resource is a duplication of the data received on the first resources, or
if PUCCH resources for the UCI signaling overlap the one or more first data transmission resources and the data has a priority higher than a priority of the UCI signaling, the first resources of one of a plurality of multiplexing configurations are determined for receiving the data and the second resources of the same multiplexing configuration are canceled.

30. The wireless communication method of claim 29, wherein the first resources and the at least one third resource are consecutive resources in the one or more data transmission resources; or the first resources and the at least one third resource are inconsecutive resources in the one or more data transmission resources.

31. (canceled)

32. The wireless communication method of claim 29, wherein the first resources of one of the plurality of multiplexing configurations are determined for receiving the data and the second resources of the same multiplexing configuration are canceled, and
wherein priority information in the resource configuration information indicates that data transmissions have a higher priority than UCI signaling transmissions.

33. (canceled)

34. (canceled)

35. A wireless terminal, comprising:
a communication unit, configured to receive, from a wireless network node, a control signaling comprising resource configuration information associated with one or more first data transmission resources, and
a processor configured to determine first resources in the one of a plurality of the first data transmission resources and/or second resources in the one of the plurality of the first data transmission resources based on a first condition,
wherein the communication unit is further configured to transmit at least one of:
data on the first resources,
an uplink control information, UCI, signaling on the second resources, or
data and an uplink control information, UCI, signaling on the second resources.

36. (canceled)

37. A wireless network node, comprising:
a communication unit, and
a processor configured to perform a wireless communication method of claim 19.

38. (canceled)

39. (canceled)
